(19) United States
(12) Patent Application Publication
(10) Pub. No.: US 2008/0026645 A1
(43) Pub. Date: Jan. 31, 2008

(54) CONNECTOR ADAPTOR AND METHOD

(75) Inventors: Naufel C. Naufel, Tempe, AZ (US); John H. Kelly, Phoenix, AZ (US)

Correspondence Address: MOTOROLA, INC., LAW DEPARTMENT, 1303 E. ALGONQUIN ROAD, SCHAUMBURG, IL, 60196, US

(73) Assignee: Motorola, Inc., Schaumburg, IL (US)

(21) Appl. No.: 11/460,003

(22) Filed: Jul. 26, 2006

(51) Int. Cl. H01R 11/09

(52) U.S. Cl. 439/798

(57) ABSTRACT

A connector adaptor (205) and method may include a terminal block (210) and a power conductor (215). The power conductor includes in-line, hyperboloid radial sockets (220) to be applied to pins 235 mounted in an array on a power distribution unit (106), and two-hole terminal connectors 225, where the two-hole terminal connectors are each coupled to a pair of threaded studs (230) extending from the terminal block, and where the connector adaptor is adapted to conduct power to an embedded computer chassis.

### BACKGROUND OF INVENTION

Prior art power distribution units for rack-mounted embedded computer systems are limited, due to spatial constraints, in the power they can supply to individual computing blades. The limited space in the rear of the power distribution unit prevents the use of larger connectors required for higher-powered inputs and outputs. Newer power distribution units may use a space saving connector to overcome this limitation. However, incoming power conductors do not use this space saving connector.

There is a need, not met in the prior art, for a connector adaptor to adapt incoming power conductors to a space saving connector for connection to a power distribution unit. Accordingly, there is a significant need for an apparatus and method that overcomes the deficiencies of the prior art outlined above.

### BRIEF DESCRIPTION OF THE DRAWINGS

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent in light of certain exemplary embodiments recited in the Detailed Description, wherein:

FIG. 1 representatively illustrates embedded computer system in accordance with an exemplary embodiment of the present invention;

FIG. 2 representatively illustrates a connector adaptor in accordance with an exemplary embodiment of the present invention; and

FIG. 3 representatively illustrates a connector adaptor coupled to a power distribution unit in accordance with an exemplary embodiment of the present invention.

Elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms “first”, “second”, and the like herein, if any, are used inter alia for distinguishing between similar elements and not necessarily for describing a sequential or chronological order. Moreover, the terms “front”, “back”, “top”, “bottom”, “over”, “under”, and the like in the Description and/or in the Claims, if any, are generally employed for descriptive purposes and not necessarily for comprehensively describing exclusive relative position. Any of the preceding terms so used may be interchanged under appropriate circumstances such that various embodiments of the invention described herein may be capable of operation in other configurations and/or orientations than those explicitly illustrated or otherwise described.

### DETAILED DESCRIPTION OF EXEMPLARY EMBODIMENTS

The following representative descriptions of the present invention generally relate to exemplary embodiments and the inventor's conception of the best mode, and are not intended to limit the applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

The terms “a” or “an”, as used herein, are defined as one, or more than one. The term “plurality,” as used herein, is defined as two, or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

A detailed description of an exemplary application is provided as a specific enabling disclosure that may be generalized to any application of the disclosed system, device and method for a connector adaptor in accordance with various embodiments of the present invention.

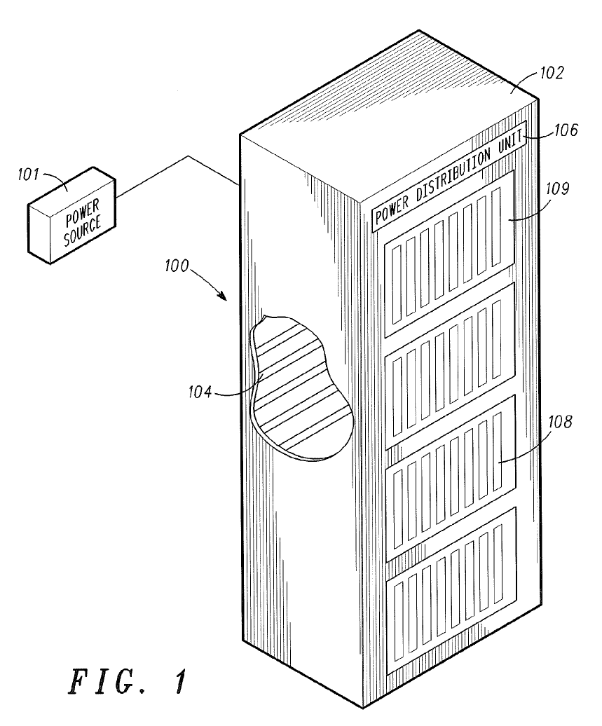

FIG. 1 representatively illustrates embedded computer system 100 in accordance with an exemplary embodiment of the present invention. As shown in FIG. 1, embedded computer system 100 may include an embedded computer frame 102, backplane 104, chassis 109, a plurality of slots for inserting computing blade 108, power distribution unit 106, and the like. Backplane 104 may be used for coupling blades placed in plurality of slots and for power distribution.

In an embodiment, a computing blade 108 may comprise a switch blade, payload blade, and the like, coupled to any number of other computing blades via backplane 104. Backplane 104 may accommodate any combination of a packet switched backplane including a distributed switched fabric or a multi-drop bus type backplane. Backplanes may support AdvancedTCA™, CompactPCI®, CompactTCA™, MicroTCA™ and the like. Computing blade 108 may add functionality to embedded computer system 100 through the addition of processors, memory, storage devices, I/O elements, and the like. In other words, a computing blade 108 may include any combination of processors, memory, storage devices, I/O elements, and the like, to give embedded computer system 100 any functionality desired by a user. In the embodiment shown, there are sixteen slots to accommodate any combination of computing blades 108. However, an embedded computer frame 102 with any number of chassis 109 or slots may be included in the scope of the invention.

In an embodiment, embedded computer system 100 can use a switch blade as a central switching hub with any number of payload blades coupled to the switch blade. Embedded computer system 100 may support a point-to-point, switched input/output (I/O) fabric. Embedded computer system 100 may include both node-to-node (for example computer systems that support I/O node add-in slots) and chassis-to-chassis environments (for example interconnecting computers, external storage systems, external Local Area Network (LAN) and Wide Area Network (WAN) access devices in a data-center environment). Embedded computer system 100 may be implemented by using one or more of a plurality of switched fabric network standards, for example and without limitation, InfiniBand™, Serial RapidIO™, Ethernet™, AdvancedTCA™, CompactPCI®, CompactTCA™, PCI Express™, and the like. Embedded computer system 100 is not limited to the use of these switched fabric network standards and the use of any switched fabric network standard is within the scope of the invention.

In one embodiment, backplane 104 can be an embedded packet switched backplane as is known in the art. In another embodiment, backplane 104 can be an overlay packet switched backplane that is overlaid on top of a backplane that does not have packet switched capability. In any embodiment of the invention, computing blades 108 may communicate with each other via a plurality of links, for example and without limitation, 100-ohm differential signaling pairs.

In an embodiment, embedded computer frame 102, chassis 109 and backplane 104 can use the CompactPCI (CPCI) Serial Mesh Backplane (CSMB) standard as set forth in PCI Industrial Computer Manufacturers Group (PICMG®) specification 2.20, promulgated by PICMG®, 301 Edgewater Place, Suite 220, Wakefield, Mass. CSMB provides infrastructure for applications such as Ethernet, Serial RapidIO, other proprietary or consortium based transport protocols, and the like. In another embodiment embedded computer frame 102 can use an Advanced Telecom and Computing Architecture (ATCA™) standard as set forth by PICMG®. The embodiment of the invention is not limited to the use of these standards, and the use of other standards is within the scope of the invention.

In an embodiment, embedded computer frame 102 and/or chassis 109 may provide redundancy in the slot configuration by providing that each slot has a corresponding slot such that computing blade 108 has a corresponding computing blade in a corresponding slot. For example, if computing blade 108 were to cease to function, a corresponding computing blade may assume the functions of computing blade 108 without interruption of service. This redundancy may hold for both switch blades and payload blades and provides embedded computer frame 102 with greater reliability.

In an embodiment, embedded computer frame 102 may be fed power by one or more power sources 101. The power source may be passed through power distribution unit 106 to distribute power to chassis 109 and computing blades 108.

In an embodiment, power distribution unit 106 may provide power to chassis 109. Power distribution unit 106 may be modular within embedded computer frame 102 and coupled to receive power from a power source 101 and distribute it to any number of chassis 109 in embedded computer frame 102.

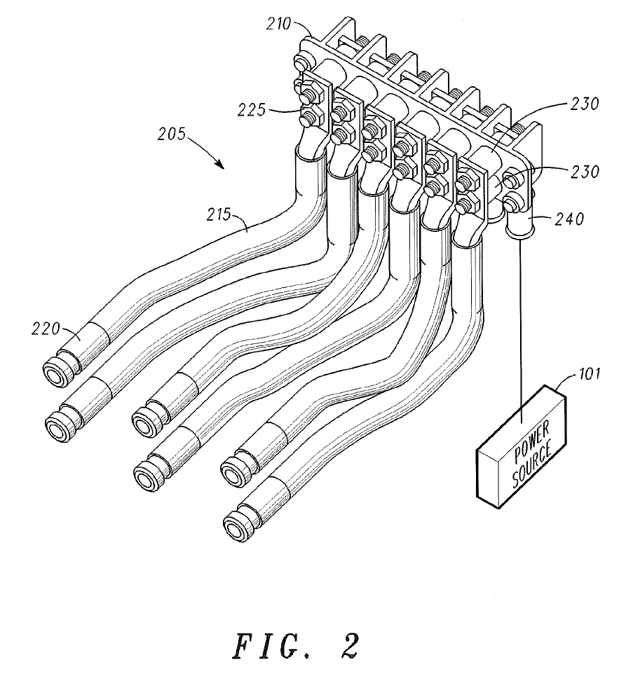

FIG. 2 representatively illustrates a connector adaptor 205 in accordance with an exemplary embodiment of the present invention. In an embodiment, connector adaptor 205 may include a terminal block 210 and a power conductor 215.

In an embodiment, terminal block 210 may include an insulating base with terminals adapted to couple to a two-hole connector terminal 225. Terminal block 210 may include two-post terminals 230 adapted to couple to a two-hole connector terminal 225. Two-post terminals 230 may each include threaded studs with nuts that may be used to clamp two-hole connector terminal 225 to terminal block 210. Terminal block 210 may include terminals adapted to couple to input power terminals 240, where power input terminals may be coupled to power source 101. Each two-post terminal 230 may have a corresponding terminal adapted to couple to an input power terminal 240. Terminal block 210 may have any number of two-hole connector terminals 225 and input power terminals 240. In an embodiment, two-hole connector terminal 225 may be clamped, soldered, and the like to power conductor 215. In a particular embodiment, two-hole connector terminal 225 may be a compression-type two-hole connector terminal.

Power conductor 215 may be a cable or any other conducting means adapted to conduct power from power source 101. Power conductor 215 may include an in-line hyperboloid radial socket 220 and a two-hole terminal connector 225. In an embodiment, two-hole terminal connector 225 is adapted to be coupled to terminal block 210. In a particular embodiment, two-hole terminal connector 225 is adapted to be coupled to two-post terminal 230 on terminal block 210.

In-line hyperboloid radial socket 220 may be comprised of multiple contacting elements that are hyperbolically arrayed around the inner diameter of the socket. Each of the contact elements may be skewed with respect to the axial direction of the socket. When a pin is coupled with the socket, the contacting elements mechanically wrap around the pin providing a normal force for a positive mechanical and electrical connection. Coupling in-line hyperboloid radial socket 220 to a pin does not require mechanical fasteners. An example of an embodiment of an in-line hyperboloid radial socket 220 is the RADSOK® connector as described in the “RADSOK® High Amperage Electrical Terminals, Technical Brief” May 2001.

Any number of two-post terminals 230, power conductors 215 and in-line hyperboloid radial sockets 220 may be included in connector adaptor 205. Further, any combination of two-post terminals 230 and input power terminals 240 may be included in terminal block 210 and be within the scope of the invention.

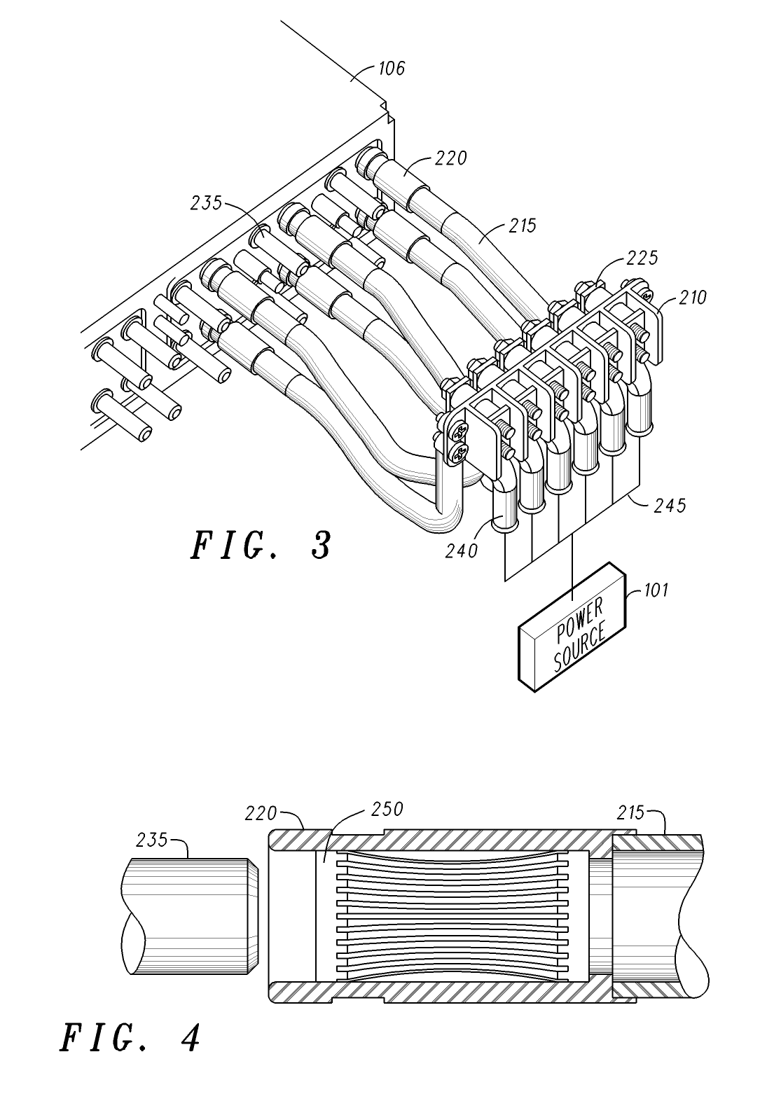

FIG. 3 representatively illustrates a connector adaptor 205 coupled to a power distribution unit 106 in accordance with an exemplary embodiment of the present invention. One or more faces of power distribution unit 106 may include one or more power ingress pins 235, where power may enter power distribution unit 106. Each power ingress pin 235 may be adapted to couple with in-line hyperboloid radial socket 220.

In an embodiment, ingress, in-line hyperboloid radial socket 220 may be comprised of multiple contacting elements that are hyperbolically arrayed around the inner diameter of the socket. Each of the contact elements may be skewed with respect to the axial direction of the socket. When the power ingress pin 235 is coupled with the socket, the contacting elements mechanically wrap around the power ingress pin 235 providing a normal force for a positive mechanical and electrical connection. Coupling in-line hyperboloid radial socket 220 to power ingress pin 235 does not require mechanical fasteners.

In-line hyperboloid radial socket 220 may be coupled to power ingress pin 235, where power ingress pin 235 is coupled to bring power to power distribution unit 106. Radial socket 220 has an in-line configuration such that the axial direction of both the radial socket 220 and the power ingress pin 235 are in substantially the same direction. This is as opposed to a non-in-line radial socket where the axial direction of the radial socket 220 and an power ingress pin 235 are offset substantially ninety degrees with respect to each other.

The in-line configuration of radial socket 220 allows more power ingress pins 235 in the limited space defined by a projection of a face of power distribution unit 106. This also allows for a greater current capacity density of the power distribution unit 106 which may be defined as the amount of current input through a face of the power distribution unit 106.

Power distribution unit 106 is adapted to distribute power to embedded computer chassis 109. In an embodiment, terminal block 210 may be coupled to embedded computer frame 102. Terminal block 210 is adapted to interface with power source 101 via input power conductor 245. Connector adaptor 205 is adapted to conduct power from power source 101 to power distribution unit 106. In other words, connector adaptor 205 may function to adapt input power conductors 245 from a two-hole terminal connector to an in-line hyperboloid radial socket 220. Since input power conductors 245 are required to use a two-hole terminal connector, connector adaptor 205 allows the space-saving in-line hyperboloid radial socket 220 to be used to connect power conductors 215 to power distribution unit 106.

In the foregoing specification, the invention has been described with reference to specific exemplary embodiments. However, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A connector adaptor, comprising:
a terminal block;
a power conductor, comprising:
an in-line, hyperboloid radial socket joined at one end of the power conductor; and
a two-hole terminal connector joined a the other end of the power conductor, wherein the two-hole terminal connector is adapted to be coupled to the terminal block, and wherein the connector adaptor is adapted to conduct high amperage power to an embedded computer chassis.

2. The connector adaptor of claim 1, wherein the terminal block is adapted to be coupled to an embedded computer frame.

3. The connector adaptor of claim 1, wherein the in-line, hyperboloid radial socket is adapted to be coupled to a power distribution unit.

4. The connector adaptor of claim 3, wherein the in-line, hyperboloid radial socket is adapted to interface with a power ingress pin on the power distribution unit.

5. The connector adaptor of claim 3, wherein the power distribution unit is adapted to distribute the high amperage power to the embedded computer chassis.

6. The connector adaptor of claim 1, wherein the terminal block is adapted to interface with a power source.

7. A method of supplying power to an embedded computer chassis, comprising:
providing a terminal block;
providing a power conductor, further comprising:
providing an in-line, hyperboloid radial socket joined at one end of the power conductor; and
providing a two-hole terminal connector joined at the other end of the power conductor, wherein the two-hole terminal connector is adapted to be coupled to the terminal block, and wherein the terminal block and the power conductor are adapted to conduct high amperage power to the embedded computer chassis.

8. The method of claim 7, further comprising coupling the terminal block to an embedded computer frame.

9. The method of claim 7, further comprising coupling the in-line, hyperboloid radial socket to a power distribution unit.

10. The method of claim 9, further comprising adapting the in-line, hyperboloid radial socket to interface with a power ingress pin on the power distribution unit.

11. The method of claim 9, further comprising adapting the power distribution unit to distribute the high amperage power to the embedded computer chassis.

12. The method of claim 7, further comprising adapting the terminal block to interface with a power source.

13. The method of claim 12, further comprising the power source supplying power to the embedded computer chassis via the terminal block and the power conductor.

14. An embedded computer system, comprising:
a terminal block;
a power conductor, comprising:
an in-line, hyperboloid radial socket joined at one end of the power conductor; and
a two-hole terminal connector joined at the other end of the power conductor, wherein the two-hole terminal connector is adapted to be coupled to the terminal block, and wherein the terminal block and the power conductor are adapted to conduct high amperage power to an embedded computer chassis.

15. The embedded computer system of claim 14, wherein the terminal block is adapted to be coupled to an embedded computer frame.

16. The embedded computer system of claim 14, wherein the in-line, hyperboloid radial socket is adapted to be coupled to a power distribution unit.

17. The embedded computer system of claim 16, wherein the in-line, hyperboloid radial socket is adapted to interface with a power ingress pin on the power distribution unit.

18. The embedded computer system of claim 16, wherein the power distribution unit is adapted to distribute the high amperage power to the embedded computer chassis.

19. The embedded computer system of claim 14, wherein the terminal block is adapted to interface with a power source.

20. The embedded computer system of claim 19, wherein the power source is adapted to supply the high amperage power to the embedded computer chassis via the terminal block and the power conductor.
